(19) United States
(12) Patent Application Publication
(10) Pub. No.: US 2020/0195805 A1
(43) Pub. Date: Jun. 18, 2020

(54) IMAGE FORMING APPARATUS, METHOD OF CONTROLLING IMAGE FORMING APPARATUS, AND RECORDING MEDIUM

(71) Applicant: Konica Minolta, Inc., Tokyo (JP)

(72) Inventor: Masatomo Matsubara, Toyohashi-shi (JP)

(73) Assignee: Konica Minolta, Inc., Tokyo (JP)

(21) Appl. No.: 16/717,465

(22) Filed: Dec. 17, 2019

(30) Foreign Application Priority Data
Dec. 18, 2018 (JP) 2018-236590

(51) Int. Cl. H04N 1/00; H04N 1/04; G03G 15/00

(52) U.S. Cl. CPC H04N 1/00896; H04N 1/00403; H04N 2201/0094; G03G 15/5004; H04N 1/04

(57) ABSTRACT

An image forming apparatus includes: an operation panel that receives from a user a transition instruction to transition a power switch of the image forming apparatus from a power-off state or a power-saving state to an activated state; and a hardware processor that adjusts respective timings to perform a voice instruction stand-by operation and a preliminary drive operation, wherein the hardware processor performs the voice instruction stand-by operation to wait for a voice instruction from the user after receiving the transition instruction, the hardware processor performs the preliminary drive operation after receiving the transition instruction but before a transition to the activated state, and upon receiving the transition instruction, the hardware processor adjusts the timings to prevent the voice instruction stand-by operation and the preliminary drive operation from overlapping each other.

### CROSS-REFERENCE TO RELATED APPLICATION

The entire disclosure of Japanese patent Application No. 2018-236590, filed on Dec. 18, 2018, is incorporated herein by reference.

### BACKGROUND

### Technical Field

The present invention relates to an image forming apparatus such as a multi-functional peripheral (MFP), and related technologies.

### Description of the Related Art

There is a technology for receiving a voice instruction by performing a voice recognition process on a voice emitted from a user during a voice instruction stand-by operation (also referred to as a voice operation mode) that is performed to wait for the voice instruction from the user (see JP 2011-39571 A).

Meanwhile, in an MFP, when a transition instruction for a transition from a power-off state or a power-saving state to a (mechanically) activated state is received from a user, a preliminary drive operation (described below) is immediately performed. The preliminary drive operation (also referred to as the initial operation) is a mechanical drive operation to be performed preliminarily before the MFP enters an activated state after the transition instruction. For example, in a printer of the MFP, a transfer operation for transferring a toner image onto an intermediate transfer belt is performed as a preliminary drive operation in an image stabilization process.

Here, in response to the transition instruction, a voice instruction stand-by operation (an operation to wait for a voice instruction from the user after the transition instruction) might be immediately started.

In this case, however, there is a possibility that a voice recognition process will not be performed properly, because the voice instruction stand-by operation and the preliminary drive operation are performed in parallel in response to the instruction for a transition to an activated state. For example, there is a possibility that the voice recognition rate will decrease.

Specifically, during the preliminary drive operation, driving sound (operating sound) is generated from the mechanical drive mechanism of the MFP. For example, during the transfer operation that is performed by the printer in the image stabilization process, rotational driving sound is generated from the intermediate transfer belt, and rotational driving sound and the like are generated from various kinds of rollers (a transfer roller, a drive roller, and the like). In a case where a user emits a voice while the preliminary drive operation and the voice instruction stand-by operation are being performed in parallel after the instruction for a transition to an activated state is issued, the driving sound generated during the preliminary drive operation overlaps the voice of the user. As a result, the voice recognition process might not be performed properly, because the voice recognition rate drops due to mixing of the driving sound (or noise) and the user's voice, for example.

### SUMMARY

One or more embodiments of the present invention provide a technology for enabling execution of a voice recognition process after reception of a transition instruction for instructing to transition from a power-off state or a power-saving state to an activated state.

An image forming apparatus of one or more embodiments of the present invention comprises: a transition instruction receiver (e.g., an operation unit or operation panel) that receives from a user a transition instruction for instructing the image forming apparatus to transition from a power-off state or a power-saving state to an activated state; and a hardware processor that performs an adjustment process to adjust respective timings to perform a voice instruction stand-by operation and a preliminary drive operation (first drive operation, second drive operation), the voice instruction stand-by operation being performed to wait for a voice instruction from the user after the transition instruction, the preliminary drive operation being a mechanical drive operation to be preliminarily performed after the transition instruction and before a transition to the activated state, wherein in response to the transition instruction, the hardware processor performs the adjustment process to prevent the voice instruction stand-by operation and the preliminary drive operation from overlapping each other.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram showing the exterior of an image processing apparatus (an MFP) according to one or more embodiments;

FIG. 2 is a diagram showing the functional blocks of the MFP according to one or more embodiments;

FIG. 3 is a diagram showing an (example) outline of a process of adjusting the respective timings to perform a voice instruction stand-by operation and a preliminary drive operation according to one or more embodiments;

FIG. 4 is a flowchart showing operation of the MFP according to one or more embodiments;

FIG. 5 is a diagram showing a subroutine process relating to a process of determining the end of the voice instruction stand-by operation according to one or more embodiments;

FIG. 6 is a flowchart showing operation of an MFP according to one or more embodiments;

FIG. 7 is a diagram showing a notification screen according to one or more embodiments;

FIG. 8 is a flowchart showing operation of an MFP according to one or more embodiments;

FIG. 9 is a diagram showing a preferential operation setting screen according to one or more embodiments;

FIG. 10 is a diagram showing the functional blocks of the MFP according to one or more embodiments;

FIG. 11 is a diagram showing a subroutine process relating to the preliminary drive operation according to one or more embodiments;

FIG. 12 is a diagram showing the presence/absence of operation of each processor for each job type according to one or more embodiments;

FIG. 13 is a diagram showing LEDs or the like for notifying that the voice instruction stand-by operation is suspended according to one or more embodiments;

FIG. 14 is a flowchart showing operation of an MFP according to one or more embodiments;

FIG. 15 is a diagram showing the configuration of a scanner according to one or more embodiments;

FIG. 16 is a diagram primarily showing the configuration and the like of a reader unit of a printer according to one or more embodiments;

FIG. 17 is a diagram showing the position and the like of sliders before and after movement according to one or more embodiments; and

FIG. 18 is a diagram showing the configuration in the vicinity of imaging units of the printer according to one or more embodiments.

### DETAILED DESCRIPTION

Hereinafter, embodiments of the present invention will be described with reference to the drawings. However, the scope of the invention is not limited to the disclosed embodiments.

### 1-1. Configuration Overview

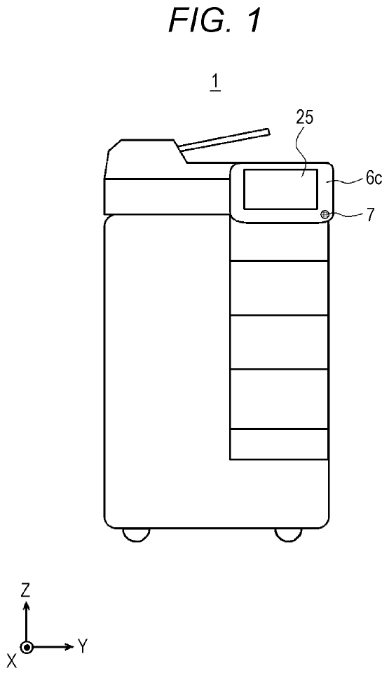

FIG. 1 is a diagram showing the exterior of a multi-functional peripheral (MFP) 1. In FIG. 1 and other drawings, directions and the like are indicated with an X-Y-Z orthogonal coordinate system.

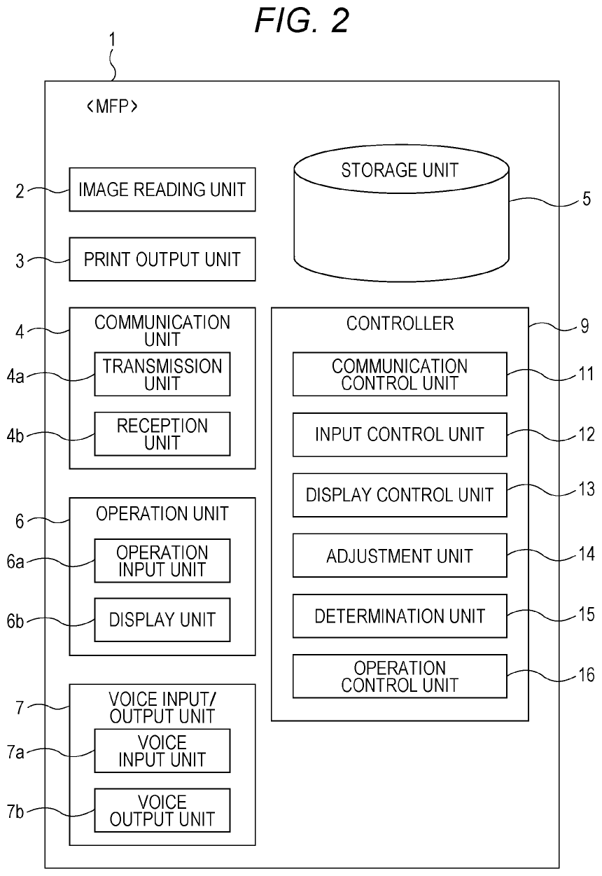

FIG. 2 is a diagram showing the functional blocks of the MFP 1.

The MFP 1 is an apparatus (also referred to as a multi-function machine) having a scan function, a copy function, a facsimile function, a box storage function, and the like. Specifically, as shown in the functional block diagram in FIG. 2, the MFP 1 includes an image reading unit 2, a print output unit 3, a communication unit 4, a storage unit 5, an operation unit 6, a voice input/output unit 7, and a controller (a control unit) 9, and achieves various functions by causing these respective components to operate in combination. The MFP 1 is also referred to as an image forming apparatus or an image processing apparatus, for example.

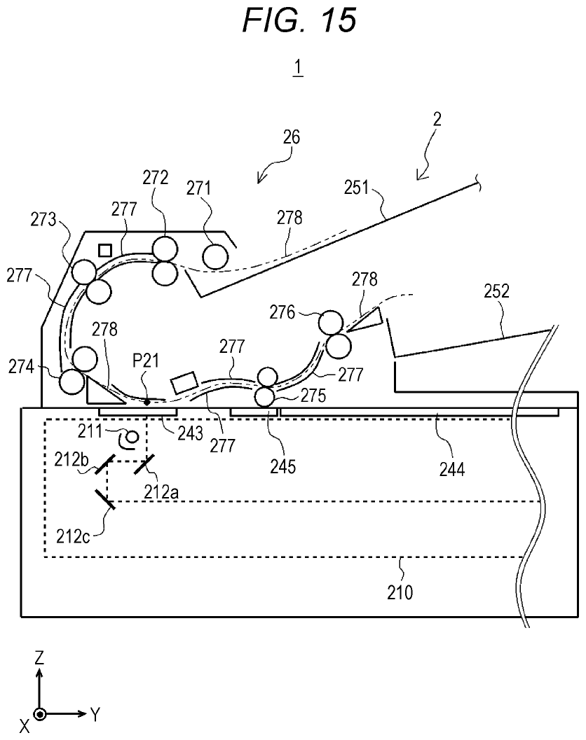

The image reading unit (also referred to as a scanner) 2 is a processor that optically reads (or scans) a document placed at a predetermined position (an auto document feeder (ADF) 26 (FIG. 15)) of the MFP 1, and generates image data (also referred to as a document image or a scanned image) of the document.

The print output unit (also referred to as a printer) 3 is a processor that prints and outputs an image onto various kinds of media such as paper, on the basis of data relating to the print target (print target data).

The communication unit 4 is a processor capable of performing facsimile communication via a public line or the like. The communication unit 4 can further perform network communication via a network. In the network communication, various kinds of protocols such as TCP/IP (Transmission Control Protocol/Internet Protocol) are used, for example. Using the network communication, the MFP 1 can exchange various kinds of data with a desired communication destination. The communication unit 4 includes a transmission unit 4a that transmits various kinds of data, and a reception unit 4b that receives various kinds of data.

The storage unit 5 includes a storage device such as a hard disk drive (HDD) and a semiconductor memory.

The operation unit 6 includes an operation input unit 6a that receives an operation input (an operation input performed on an operation panel unit 6c or the like) directed to the MFP 1, and a display unit 6b that displays and outputs various kinds of information. For example, the operation unit 6 can receive a transition instruction from the user to instruct the MFP 1 to transition from a power-saving state to an activated state (a mechanical activated state), using the operation unit 6. The operation unit 6 also functions as a transition instruction reception unit that receives the transition instruction from the user. Here, the activated state is a state in which a job can be executed (a state in which the preparation for job execution has been completed), and is also referred to as a job executable state (operation preparation completed state).

This MFP 1 includes the plate-like operation panel unit 6c (see FIG. 1). The operation panel unit 6c also includes a touch panel 25 (see FIG. 1) on its front surface side. The touch panel 25 functions as part of the operation input unit 6a, and also functions as part of the display unit 6b. The touch panel 25 is formed with a liquid crystal display panel, and various sensors and the like embedded in the liquid crystal display panel. The touch panel 25 is capable of receiving various kinds of operation inputs, as well as displaying various kinds of information.

The voice input/output unit 7 (see FIG. 1) includes a voice input unit 7a (such as a microphone) capable of inputting voice, and a voice output unit 7b (such as a speaker) capable of outputting voice. The voice input/output unit 7 is disposed on the front surface side (specifically, on the operation unit 6) of the main body of the MFP 1, for example.

The voice input unit 7a is capable of recognizing a voice uttered by a user (by performing a voice recognition process), and receiving a voice input (an instruction by voice) by the user. For example, while performing a voice instruction stand-by operation (an operation to stand by for a voice instruction from the user after an instruction for a transition from a power-saving state to an activated state), the voice input unit 7a can perform a voice recognition process on a voice from the user, to receive a voice instruction. The voice input unit 7a can also receive from the user a transition instruction (also referred to as a voice transition instruction) by voice to instruct the MFP 1 to transition from a power-saving state to an activated state. The voice input unit 7a also functions as a transition instruction reception unit that receives such a transition instruction (a voice transition instruction) from the user.

The voice instruction stand-by operation is also referred to as an operation to wait for a voice instruction in a state (an operation mode) in which the MFP 1 can receive an instruction by voice. During the voice instruction stand-by operation, the MFP 1 performs voice recognition on the speech relating to the operator's instruction, and receives the contents of the recognized instruction. In other words, the voice instruction stand-by operation is also expressed as an operation (a state) in which the MFP 1 activates the voice recognition function and waits for a voice instruction.

The controller 9 is a control device that is included in the MFP 1, and comprehensively controls the MFP 1. The controller 9 is formed as a computer system that includes a central processing unit (CPU) (also referred to as a microprocessor or a computer processor or a hardware processor) and various semiconductor memories (a RAM and a ROM). The controller 9 functions as the respective processors, as the CPU executes a predetermined software program (hereinafter also referred to simply as the program) stored in a ROM (such as an EEPROM (registered trademark)). The program (more specifically, a program module group) may be recorded in a portable recording medium such as a USB memory, be read out from the recording medium, and be installed into the MFP 1. The program may be downloaded via a network or the like, and be installed into the MFP 1.

Specifically, the controller 9 executes the above program or the like, to function as various kinds of processors including a communication control unit 11, an input control unit 12, a display control unit 13, an adjustment unit 14, a determination unit 15, and an operation control unit 16, as shown in FIG. 2.

The communication control unit 11 is a processor or a hardware processor that controls a communication operation with another device in cooperation with the communication unit 4 or the like.

The input control unit 12 is a control unit that controls an input operation or the like performed on the operation input unit 6a (the touch panel 25 or the like).

The display control unit 13 is a processor that controls a display operation in the display unit 6b (the touch panel 25 or the like).

The adjustment unit 14 is a processor or a hardware processor that performs an adjustment process for adjusting (determining) the timing to perform a preliminary drive operation (described later) and the timing to perform a voice instruction stand-by operation. Specifically, in response to a transition instruction for instructing the MFP 1 to transition from a power-saving state to an activated state, the adjustment unit 14 performs the adjustment process so that the voice instruction stand-by operation and the preliminary drive operation will not overlap each other (in other words, to shift the period of execution of the voice instruction stand-by operation and the period of execution of the preliminary drive operation from each other).

The determination unit 15 is a processor or a hardware processor that performs various kinds of determining operations.

The operation control unit 16 is a control unit that controls execution of a preliminary drive operation in each processor. A preliminary drive operation is a mechanical drive operation to be preliminarily performed before the MFP 1 enters an activated state after an instruction for a transition from a power-saving state (also referred to as a sleep state) or a power-off state to the activated state (also referred to as the normal state). As will be described later, the MFP 1 is capable of performing a preliminary drive operation that includes an operation to move sliders 220, an operation to lower a sheet feed roller 271, a transfer operation, and an operation to rotate a fixing roller 326. The operation control unit 16 causes the respective processors (specifically, a first processor and a second processor, or the scanner 2 and the printer 3) to perform a preliminary drive operation, in synchronization with the execution timing adjusted by the adjustment unit 14 (the timing to perform the preliminary drive operation).

The above described various operations are performed primarily by the CPU of the controller 9 executing a software program. However, the above described various operations are not necessarily performed in that manner, but may be performed with dedicated hardware or the like provided in the MFP 1 (specifically inside or outside the controller 9). For example, all or some of the communication control unit 11, the input control unit 12, the display control unit 13, the adjustment unit 14, the determination unit 15, the operation control unit 16 (FIG. 2), and the like may be formed with one or more pieces of dedicated hardware.

### 1-2. Configuration of the Scanner

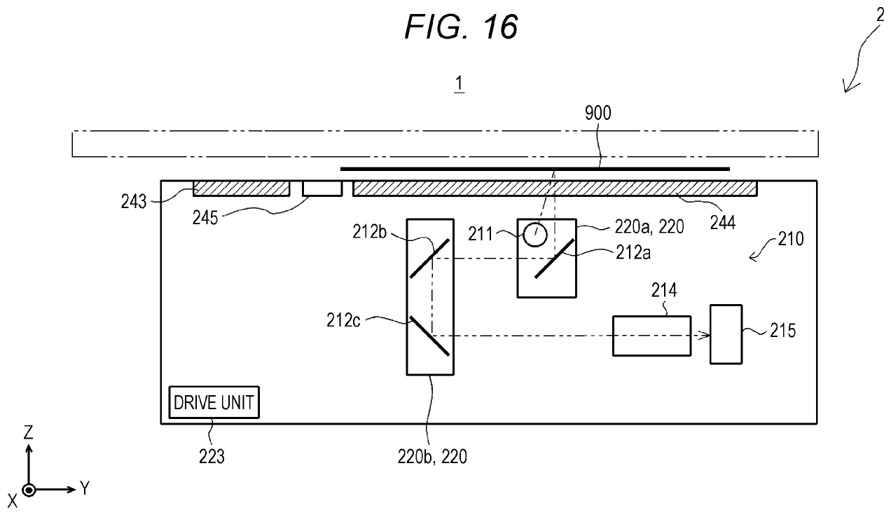

FIG. 15 is a diagram schematically showing the configuration of the scanner 2. FIG. 16 is a diagram primarily showing the configuration and the like of a reader unit 210 of the scanner 2. FIG. 16 does not show the configuration related to the ADF 26.

As shown in FIG. 16, the scanner 2 includes the reader unit 210.

Here, the reader unit 210 is designed as a reading unit of a reduction optical system. The reader unit 210 includes a light source 211, mirrors 212 (212a, 212b, and 212c), a lens (imaging optics) 214, and an imaging unit (an image sensor (an imaging element)) 215. Each of the components of the reader unit 210 is disposed on the lower side (on the inner side) of a transparent platen glass 244 (the document placement surface). Light emitted (released) from the light source 211 toward a document 900 located above the light source 211 passes through the platen glass 244 (or a glass 243), and is reflected by the document 900. The reflected light then reaches the image sensor 215. Thus, an image of the document 900 is acquired.

Further, the light source 211 includes a plurality of light-emitting elements 211E (not shown), and the plurality of light-emitting elements (a plurality of partial light sources) 211E is an array of light-emitting elements that are one-dimensionally (linearly) arranged in the main scanning direction (X-direction). In other words, the light source 211 is a linear light source extending in the main scanning direction. The plurality of light-emitting elements 211E is formed with several tens of light-emitting diodes (LEDs), for example. The plurality of light-emitting elements 211E can be turned on independently of one another.

A linear image sensor (a CCD line sensor in this example) in which a plurality of light receiving elements (pixels) is one-dimensionally (linearly) arranged in the main scanning direction (X-direction) is used as the image sensor 215. In other words, the image sensor 215 is a photoelectric conversion element including a plurality of pixels arranged in the main scanning direction. The photoelectric conversion element converts the reflected light, which has been emitted from the light source 211 toward the document 900 and been reflected by the document 900, into an image signal. Thus, a “line image” that is a linear image of the document 900 in the main scanning direction is acquired.

The light source 211 of the reader unit 210 is disposed on the lower side of the platen glass 244, and emits illumination light upward, to illuminate, from below, the scan target surface (the lower surface) of the document placed on the platen glass 244 (a document table). The light from the light source 211 passes through the platen glass 244, and is reflected by the scan target surface of the document 900. The optical image corresponding to the reflected light is further reflected by the mirrors 212a, 212b, and 212c, is reduced by passing through the lens 214, and is then received by the image sensor 215. The image sensor 215 acquires line images in the sheet width direction (the main scanning direction) at once. Thus, a linear image (a line image) at a certain sub scanning direction position (Y) on the document 900 is acquired.

Further, the reader unit 210 includes two movable parts 220a and 220b (collectively referred to as the movable part 220) that can move in the sub scanning direction (Y-direction). The movable part 220a is provided with the light source 211 and the mirror 212a, and the movable part 220b is provided with the mirrors 212b and 212c. As the movable parts (also referred to as slide parts or sliders) 220a and 220b move in the sub scanning direction (Y-direction), linear images (line images) at the respective sub scanning direction positions (Y) on the document 900 placed on the platen glass 244 are acquired. The movable parts 220a and 220b are driven by a slider drive unit 223 (a drive mechanism including a motor and gears). When the movable parts 220a and 220b move, the movable part 220b moves half the distance equivalent to the movement of the movable part 220a, so that a constant optical path length is maintained between each reflection position of the reflected light from the document and the image sensor 215.

As shown in FIG. 15, the MFP 1 also includes the ADF 26.

The ADF 26 conveys the document along a document conveyance path (a conveyance path) 278 from the upstream side to the downstream side. The ADF 26 has a plurality of conveyance rollers (specifically, a plurality of conveyance roller pairs or the like) including the sheet feed roller (a pickup roller) 271, separation rollers 272, timing rollers 273, pre-reading rollers 274, and post-reading rollers 275 and 276. The documents (the documents to be read) placed on a document tray 251 (a document placement unit) are sent toward the separation rollers 272 by the sheet feed roller 271, and are then sequentially conveyed to the downstream side in the conveyance direction by the respective rollers 272, 273, and 274. The documents are conveyed along a conveyance path 278 formed by the respective rollers 272, 273, 274, 275, and 276, a guide member 277, and the like, to move toward a document catch tray 252. The documents are separated by the separation rollers 272, and are conveyed one by one. Further, the documents are conveyed from the upstream side to the downstream side, while being read by the reader unit 210 at a position (a document reading position P21) immediately above the glass 243.

### 1-3. Configuration of the Printer

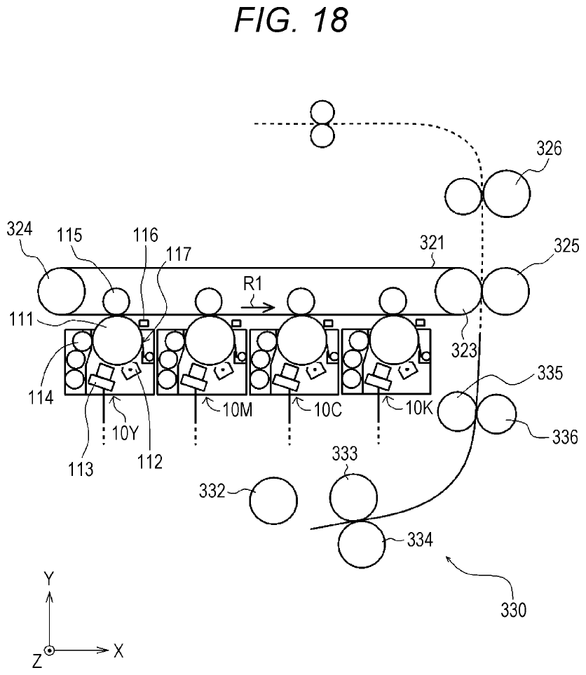

FIG. 18 is a diagram showing the configuration in the vicinity of the imaging units of the printer 3.

As shown in FIG. 18, the MFP 1 includes a plurality (specifically, four) of imaging units 10 (specifically, 10Y, 10M, 10C, and 10K). Specifically, the MFP 1 includes a yellow imaging unit 10Y, a magenta imaging unit 10M, a cyan imaging unit 10C, and a black imaging unit 10K. Each imaging unit 10 forms an image in each corresponding color component (the color component of yellow (Y), magenta (M), cyan (C), or black (K)) of the final output image by an electrophotographic technique, and transfers the image onto an intermediate transfer belt (also referred to as an intermediate transfer member) 321. The images in the respective color components superimposed on the intermediate transfer belt 321 are further transferred onto a paper sheet (a transfer material), so that a full-color image is formed on the paper sheet. The intermediate transfer belt 321 is also expressed as an image carrier that temporarily carries toner images transferred from the respective photosensitive members.

Mainly under the lower linear portion of the intermediate transfer belt 321 stretched between a drive roller 323 and a stretch roller 324, the four imaging units 10 (10Y, 10M, 10C, and 10K) are arranged in series along the lower linear portion of the intermediate transfer belt 321. Each imaging unit 10 includes a photosensitive member 111, a charger 112, an exposure device 113, a developing device 114, a first transfer device (a primary transfer device) 115, an eraser (a neutralization device) 116, and a cleaner 117. Specifically, in each imaging unit 10, the charger 112, the exposure device 113, the developing device 114, the first transfer device 115, the eraser 116, and the cleaner 117 are arranged so as to surround the outer periphery of the substantially cylindrical photosensitive member 111. Among these components, the first transfer device 115 (specifically, the transfer roller) is disposed at a position facing the photosensitive member 111, with the intermediate transfer belt 321 being interposed in between.

As the drive roller 323 is driven, the intermediate transfer belt 321 moves in the direction of an arrow R1 (FIG. 18). Further, a transfer roller (a secondary transfer roller) 325 is provided at a position facing the drive roller 323, with the intermediate transfer belt 321 being interposed in between.

A sheet feeder unit 330 is provided below the respective imaging units 10 (on the upstream side in the conveyance path). The sheet feeder unit 330 includes a feed roller 332, a sheet feed roller 333, a suction roller 334, and registration rollers 335 and 336.

The fixing device (a fixing roller) 326 is provided on the downstream side in the direction of conveyance of a paper sheet that has passed through the position of the transfer roller (secondary transfer roller) 325, and a sheet ejecting unit is provided on the further downstream side in the conveyance direction.

### 1-4. Preliminary Drive Operation

In the MFP 1, when the MFP 1 transitions (returns) from a power-saving state (or a power-off state (described later)) to an activated state, the preliminary drive operation (also referred to as the initial operation) is performed. During the preliminary drive operation, driving sound (operating sound) is generated from the mechanical drive mechanism.

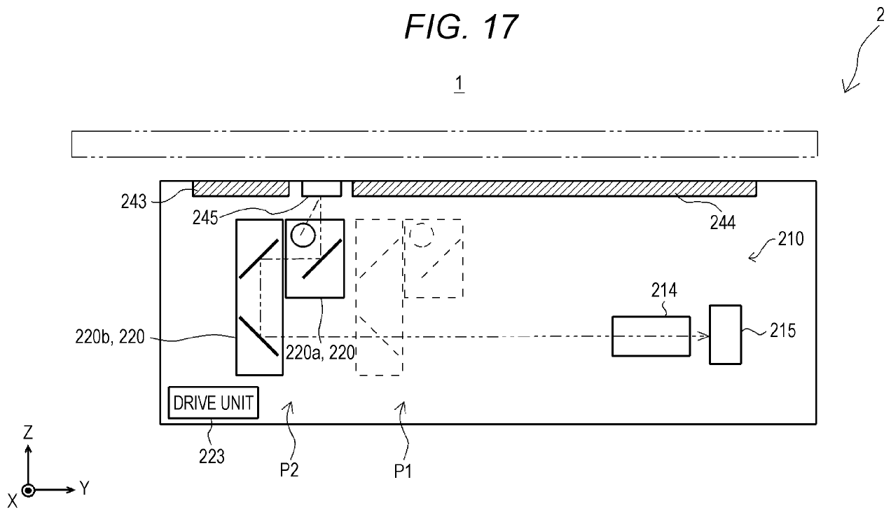

For example, in a transition from a power-saving state to an activated state, the scanner 2 performs a shading correction process. The shading correction process is a correction process for eliminating luminance unevenness caused by differences in light receiving sensitivity among the light receiving elements (the image sensor 215 (FIG. 16)). In the shading correction process, the operation to move the movable parts (sliders) 220 (FIG. 17) is performed as the preliminary drive operation.

Specifically, in a transition from a power-saving state to an activated state, the sliders 220 move from the home position (the reference position for the reader unit 210 to read an image of the document placed on the platen glass 244) P1 to a shading correction position P2 (see FIG. 17). The shading correction position P2 is the position of the sliders 220 at a time when the reader unit 210 receives the reflected light from a shading correction plate 245, or, in short, the position of the sliders 220 at a time when a shading correction operation is performed. After the shading correction process is performed at the shading correction position P2, the sliders 220 move again from the shading correction position P2 to the home position P1. During these slider moving operations described above, operating sound (moving sound) or the like is generated from the sliders 220.

Further, in the transition from a power-saving state to an activated state, the scanner 2 performs a preliminary drive operation that is a lowering operation to lower the sheet feed roller (pickup roller) 271 (FIG. 15) in the ADF 26 from a predetermined position (the normal position) to a position to be in contact with the document tray 251. During the operation to lower the sheet feed roller 271, moving sound is generated from the sheet feed roller 271 (or sound of collision with the document tray 251 is generated). In addition to the lowering operation, a raising operation to return (raise) the sheet feed roller 271 to the normal position may be performed as the preliminary drive operation.

Further, in the transition from a power-saving state to an activated state, the image stabilization process is performed in the printer 3 of the MFP 1. In the image stabilization process, a transfer operation to transfer toner images from the respective imaging units 10 (specifically, the photosensitive members 111 of the respective imaging units 10) onto the intermediate transfer belt 321 (FIG. 18) is performed as the preliminary drive operation. The transfer operation is realized by driving of the intermediate transfer belt 321 and driving or the like of various rollers (such as the drive roller 323). During the transfer operation, rotational driving sound is generated from the intermediate transfer belt 321 and the like.

Further, in the transition from a power-saving state to an activated state, a warm-up operation (a temperature raising operation) for the fixing device (fixing roller) 326 (FIG. 18) is also performed as the preliminary drive operation in the printer 3. In the warm-up operation, the fixing roller 326 is heated by a heater in a heating process. During the heat treatment, the fixing roller 326 rotates, and rotational driving sound is generated from the fixing roller 326.

### 1-5. Operation

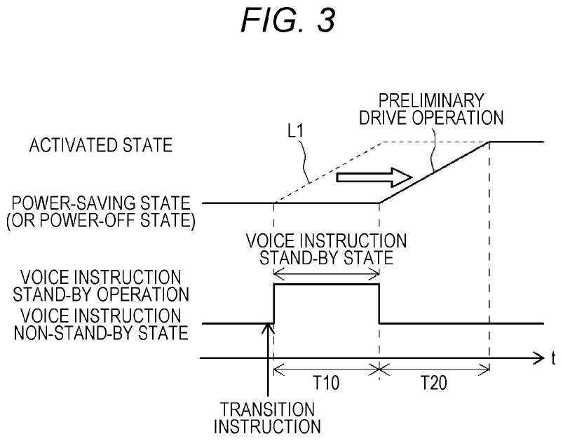

FIG. 3 is a diagram showing an (example) outline of a process of adjusting the respective timings to perform a voice instruction stand-by operation and a preliminary drive operation.

In this example, when an instruction for a transition from a power-saving state to an activated state is received, a preliminary drive operation is immediately started in response to the transition instruction (see a dashed line L1 in FIG. 3), and a voice instruction stand-by operation may be performed in parallel with the preliminary drive operation. In such an MFP, however, in a case where the user emits a voice after the transition instruction is issued (or immediately after the issuance), there is a possibility that the driving sound of the mechanical drive mechanism will overlap the user's voice, resulting in a decrease in the voice recognition rate in a voice recognition process.

In one or more embodiments, on the other hand, when the transition instruction is received, the respective timings to perform the voice instruction stand-by operation and the preliminary drive operation are adjusted so that the voice instruction stand-by operation and the preliminary drive operation will not overlap each other. Specifically, in response to the transition instruction, only the voice instruction stand-by operation is started, between the voice instruction stand-by operation and the preliminary drive operation. After the end of the voice instruction stand-by operation (specifically, in response to the end of the voice instruction stand-by operation), the preliminary drive operation is started.

Such an operation will be described below in detail.

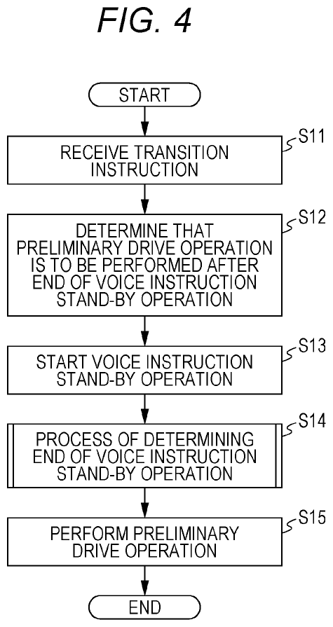

FIG. 4 is a flowchart showing operation of the MFP 1.

In step S11, the MFP 1 receives from the user an instruction for a transition from a power-saving state to an activated state. Examples of instructions to transition from a power-saving state to an activated state include a transition instruction issued through a pressing operation of pressing an operation button (not shown) in the operation unit 6, and a transition instruction issued through a voice input operation of vocally inputting a return instruction word (such as “return”) for instructing to return (transition) to an activated state.

Although a transition instruction from a power-saving state to an activated state is received in this example, the present invention is not limited to this, and an instruction for a transition from a power-off state to an activated state may be received. For example, an instruction for a transition from a power-off state to an activated state may be received in a switching operation (an operation to switch from a power-off state to a power-on state) of the power switch (not shown) of the MFP 1.

When an instruction for a transition to an activated state is received from the user, the MFP 1 performs an adjustment process of adjusting the respective timings to perform the voice instruction stand-by operation and the preliminary drive operation (step S12). In other words, the MFP 1 determines the order of execution of the voice instruction stand-by operation and the preliminary drive operation.

Specifically, the MFP 1 performs the adjustment process so that the preliminary drive operation will be performed after the end of the voice instruction stand-by operation. More specifically, the MFP 1 determines that the preliminary drive operation is not to be started immediately in response to the transition instruction, but the voice instruction stand-by operation is to be started in response to the transition instruction, and the preliminary drive operation is to be started after the end of the voice instruction stand-by operation. In other words, the MFP 1 delays the timing to start the preliminary drive operation from the point of time immediately after the issuance of the transition instruction to the point of time at the end of the voice instruction stand-by operation.

In this manner, the MFP 1 adjusts the respective timings to perform the voice instruction stand-by operation and the preliminary drive operation (by shifting the execution period T10 (FIG. 3) for the voice instruction stand-by operation and the execution period T20 for the preliminary drive operation from each other) so that the voice instruction stand-by operation and the preliminary drive operation will not overlap each other. In other words, the mutual relationship between the timing to perform the voice instruction stand-by operation and the timing to perform the preliminary drive operation is adjusted.

The process then proceeds from step S12 on to step S13, and the MFP 1 performs (starts) the voice instruction stand-by operation. In other words, a voice instruction stand-by period for waiting for a voice instruction from the user after the instruction for a transition to an activated state is started.

Of the operations (transition operations) to be performed in the MFP 1 in a transition to an activated state, the operations other than the preliminary drive operation are immediately started in response to the transition instruction. For example, an operation to energize the operation unit 6 and/or the controller 9 is started immediately in response to the transition instruction. That is, of the operations to transition to an activated state (a plurality of types of transition operations), the operations that do not generate any driving sound from the mechanical drive mechanism are performed in response to the transition instruction (in parallel with the voice instruction stand-by operation), and the operation that generates driving sound from the mechanical drive mechanism is performed after the end of the voice instruction stand-by operation.

The process then proceeds from step S13 on to step S14, and the MFP 1 performs a process of determining the end of the voice instruction stand-by operation.

Specifically, the voice instruction stand-by operation is performed until it is determined that the voice instruction has been completed, or until a silent state has lasted for longer than a predetermined time.

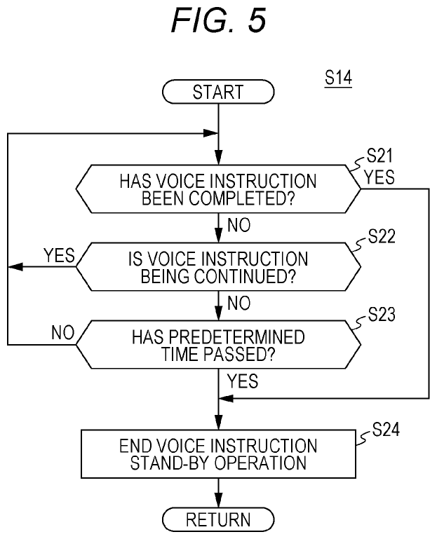

FIG. 5 is a diagram showing a subroutine process relating to the process (step S14) of determining the end of the voice instruction stand-by operation.

First, in step S21 (FIG. 5), the MFP 1 determines whether a voice instruction (specifically, a voice instruction including a job setting instruction and a job execution instruction) has been completed. Specifically, the MFP 1 determines whether a voice instruction has been completed, on the basis of whether a completion instruction word for instructing the MFP 1 to complete the voice instruction has been input by voice (or been spoken). The completion instruction word for a voice instruction may be a job execution instruction word (such as “execute”) for instructing the MFP 1 to execute a job, for example.

If a completion instruction word has been input by voice, it is determined in step S21 that a voice instruction has been completed, and the process proceeds from step S21 on to step S24.

The MFP 1 then ends the voice instruction stand-by operation (step S24). The operation after step S24 will be described later.

If any completion instruction word has not been input by voice, it is determined in step S21 that the voice instruction has not been completed yet, and the process proceeds from step S21 on to step S22.

In step S22, the MFP 1 determines whether the voice instruction is being continued (a setting instruction is issued). Specifically, it is determined whether there is a silent state.

If the voice instruction is being continued (not in a silent state), the process returns from step S22 to step S21. While the voice instruction is being continued, the processes in steps S21 and S22 are repeated.

If the voice instruction is not being continued (in a silent state), on the other hand, the process proceeds from step S22 on to step S23.

In step S23, the MFP 1 determines whether the silent state (a state in which any voice instruction (voice input) is not received) has lasted for longer than a predetermined time (10 seconds, for example).

For example, in a case where the user starts speaking (again) before the silent state reaches the predetermined time, it is determined in step S23 that the silent state has not lasted for longer than the predetermined time, and the process returns from step S23 to step S21.

If the silent state has reached the predetermined time, on the other hand, the process proceeds from step S23 on to step S24, and the voice instruction stand-by operation comes to an end.

In this manner, the process (step S14) of determining the end of the voice instruction stand-by operation is performed.

For example, after a transition instruction is issued (step S11), if the user utters “Execute a job to copy the document on both sides of an A4 paper sheet” during the voice instruction stand-by operation, the following operation is performed. Specifically, while the user is uttering “a job to copy the document on both sides of an A4 paper sheet”, the processes in steps S21 and S22 are repeated. In a case where a silent state occurs temporarily while a job setting instruction is issued or the like (for example, a case where the user does not make any sound for a few seconds after uttering “the document”), the process proceeds from step S22 on to step S23. After that, when the user starts speaking again within a predetermined time, the process returns from step S23 to step S21. When the user utters “execute” (a completion instruction word), it is determined in step S21 that the voice instruction has been completed, and the process proceeds from step S21 on to step S24. The voice instruction stand-by operation then comes to an end (step S24), and, in response to the end of the voice instruction stand-by operation, the process proceeds from step S14 on to step S15 (FIG. 4).

For example, in a case where the user does not make any sound after a transition instruction is issued (step S11), the processes in steps S21 through S23 are repeated. After that, in response to the silent state lasting for longer than the predetermined time (10 seconds, for example), the process proceeds from step S23 on to step S24. The voice instruction stand-by operation then comes to an end (step S24), and, in response to the end of the voice instruction stand-by operation, the process proceeds from step S14 (FIG. 4) on to step S15.

In step S15 (FIG. 4), the MFP 1 (specifically, the adjustment unit 14 and the operation control unit 16) performs (starts) the preliminary drive operation. The contents of the preliminary drive operation are the same as above. Specifically, in the scanner 2 of the MFP 1, a slider moving operation or the like in a shading correction process is executed as the preliminary drive operation. Further, on the printer 3 of the MFP 1, a transfer operation or the like in an image stabilization process is performed as the preliminary drive operation. The preliminary drive operation in the scanner 2 and the preliminary drive operation in the printer 3 are performed in parallel.

After that, the MFP 1 executes the job, in accordance with the voice instruction received in the voice instruction stand-by operation.

As described above, according to one or more embodiments, in response to an instruction for a transition from a power-saving state to an activated state, the timing to perform a voice instruction stand-by operation and the timing to perform a preliminary drive operation are adjusted so that the voice instruction stand-by operation and the preliminary drive operation will not overlap each other (see FIG. 3). Thus, it may perform a voice recognition process after reception of a transition instruction for instructing to transition from a power-saving state to an activated state.

Specifically, in one or more embodiments described above, in response to the transition instruction, an adjustment process is performed so that that a preliminary drive operation will be performed after the end of a voice instruction stand-by operation. As a result, even in a case where the user emits a voice immediately after issuance of a transition instruction, driving sound of the mechanical drive mechanism of the MFP 1 does not overlap the user's voice. Thus, it is possible to prevent a decrease in the voice recognition rate due to an overlap between the driving sound of the mechanical drive mechanism of the MFP 1 and the user's voice.

The description below will focus on the differences from the embodiments described above.

In the embodiments described above, in a case where an instruction for a transition from a power-saving state to an activated state is issued by any technique, it is determined that a preliminary drive operation is to be performed after the end of a voice instruction stand-by operation (step S12 (FIG. 4)).

In this case, after giving the instruction for a transition from the power-saving state to the activated state, there is a relatively high possibility that the user keeps giving the instruction to the MFP 1, using the technique (an operation input with a finger on a voice input/operation member) used for giving the transition instruction.

For example, in a case where the user has given the transition instruction by voice, there is a relatively high possibility that the user will continue to give the instruction to the MFP 1 by voice. On the contrary, there is a relatively low possibility that the user gives an instruction to the MFP 1 using the operation unit 6 (the operation buttons and/or the touch panel 25 in the operation unit 6), even though the user has given the transition instruction by voice (or there is a relatively low possibility that the user uses a different technique from the technique used for giving the transition instruction).

Further, in a case where the user has given the transition instruction using the operation unit 6 (a technique other than voice), there is a relatively high possibility that the user will continue to give the instruction to the MFP 1 using the operation unit 6. On the contrary, there is a relatively low possibility that the user will give the instruction to the MFP 1 by voice, though the user has given the transition instruction using the operation unit 6.

In view of this, in one or more embodiments, the respective timings to perform a voice instruction stand-by operation and a preliminary drive operation are adjusted on the basis of the technique used for giving the instruction for a transition from a power-saving state to an activated state.

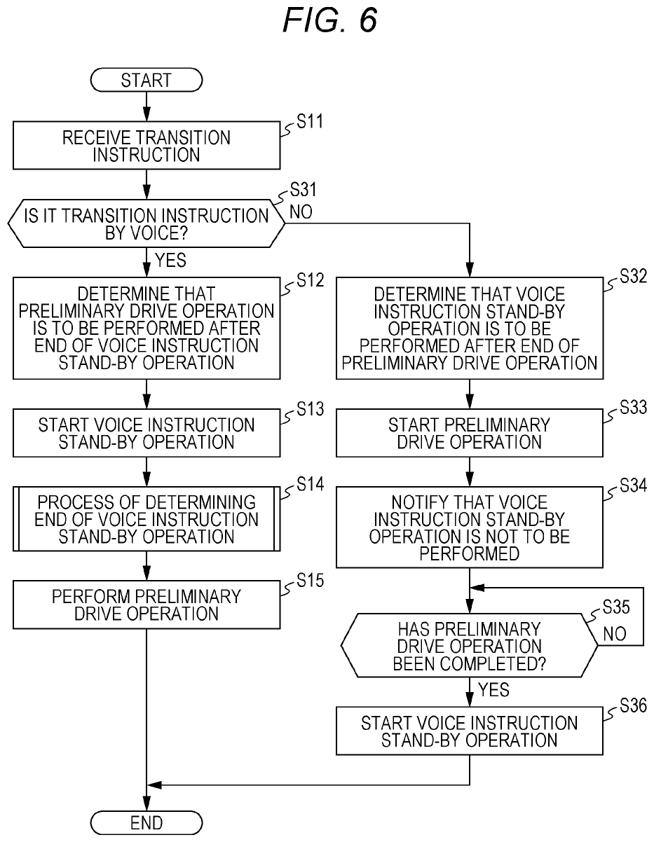

FIG. 6 is a flowchart showing operation of an MFP 1 according to one or more embodiments.

In one or more embodiments, the processes in steps S31 through S36 are performed, in addition to the processes in steps S11 through S15.

Specifically, when an instruction for a transition from a power-saving state to an activated state is received (step S11), the MFP 1 determines whether the transition instruction has been issued by voice (step S31). In other words, depending on whether the transition instruction has been issued by voice, which one of the voice instruction stand-by operation and the preliminary drive operation is to be performed first (the order of execution of the voice instruction stand-by operation and the preliminary drive operation) is determined.

In a case where the transition instruction has been issued by voice, the process proceeds from step S31 on to steps S12 through S15. The contents of the processes in steps S12 through S15 are the same as those in one or more embodiments (FIGS. 4 and 5). Specifically, it is determined that the preliminary drive operation is to be performed after the end of the voice instruction stand-by operation (step S12). The voice instruction stand-by operation is then started (step S13). After the end of the voice instruction stand-by operation (step S14), the preliminary drive operation is performed (step S15).

In a case where the transition instruction has been issued not by voice (but using operation buttons in the operation unit 6, for example), on the other hand, the process proceeds from step S31 on to step S32.

In step S32, the MFP 1 performs an adjustment process so that the voice instruction stand-by operation will be performed after the end of the preliminary drive operation. Specifically, the MFP 1 determines that the preliminary drive operation is to be started in response to the transition instruction, and the voice instruction stand-by operation is to be performed after the end of the preliminary drive operation. In other words, the MFP 1 determines that the voice instruction reception period is to be started after the end of the period of execution of the preliminary drive operation (this period is also referred to as the preliminary drive operation period).

The process then proceeds from step S32 on to step S33, and the MFP 1 performs (starts) the preliminary drive operation. The contents of the preliminary drive operation are the same as those of the embodiments described above. During the preliminary drive operation, the user cannot give any instruction to the MFP 1 by voice, but can give an instruction to the MFP 1 using the operation unit 6 (the operation buttons and/or the touch panel 25 in the operation unit 6) of the MFP 1.

The MFP 1 further performs a notification process to notify the user that the voice instruction stand-by operation is not to be performed before (i.e., until) the end of the preliminary drive operation (in other words, the voice instruction stand-by operation is suspended) (step S34).

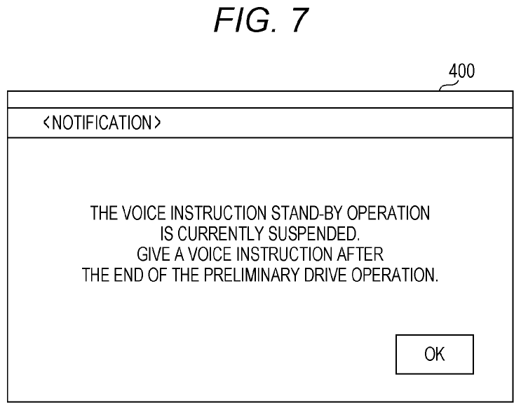

FIG. 7 is a diagram showing a notification screen 400 for notifying that the voice instruction stand-by operation is not to be performed before the end of the preliminary drive operation. The MFP 1 displays the notification screen 400 (FIG. 7) on the touch panel 25 of the MFP 1, to notify the user that the voice instruction stand-by operation is not to be performed before the end of the preliminary drive operation.

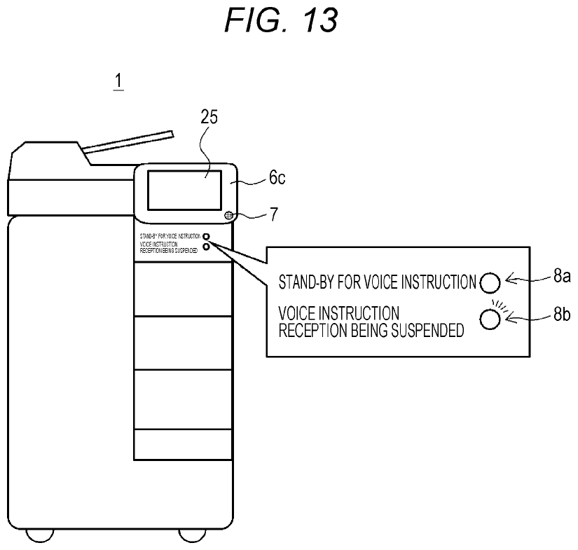

In this example, to notify the user that the voice instruction stand-by operation is not to be performed before the end of the preliminary drive operation, the notification screen 400 is displayed on the touch panel 25 (FIG. 7), but the present invention is not limited to this. For example, a notification message indicating that the voice instruction stand-by operation is not to be performed before the end of the preliminary drive operation may be output by voice. An LED 8a indicating that the voice instruction stand-by operation is being performed and an LED 8b indicating that the voice instruction stand-by operation is not being performed may be provided in a lower portion of the operation unit 6 of the MFP 1 (see FIG. 13). In that case, the LED 8a is turned off, and the LED 8b is turned on, to notify that the voice instruction stand-by operation is not to be performed.

In step S35, the MFP 1 determines whether the preliminary drive operation (all the preliminary drive operations in the respective processors) has been completed.

When the preliminary drive operation ends, the process proceeds from step S35 on to step S36, and the MFP 1 performs (starts) the voice instruction stand-by operation. In a case where the user wishes to give an instruction to the MFP 1 by voice, the user can give a voice instruction to the MFP 1 after the end of the preliminary drive operation and after the start of the voice instruction stand-by operation.

As described above, according to one or more embodiments, in response to an instruction for a transition from a power-saving state to an activated state, the timing to perform a voice instruction stand-by operation and the timing to perform a preliminary drive operation are adjusted so that the voice instruction stand-by operation and the preliminary drive operation will not overlap each other. Thus, it may perform a voice recognition process after reception of a transition instruction for instructing to transition from a power-saving state to an activated state.

Further, in one or more embodiments, in a case where the transition instruction is given by voice, an adjustment process is performed so that the preliminary drive operation will be performed after the end of the voice instruction stand-by operation. In other words, in a case where voice is likely to be used for an instruction (an instruction directed to the MFP 1) after the transition instruction, it is determined that the voice instruction stand-by operation is to be started in response to the transition instruction, and the preliminary drive operation is to be performed after the end of the voice instruction stand-by operation. Thus, it may perform a voice recognition process, while taking the user's intention into consideration.

Further, in one or more embodiments, in a case where it is determined that the voice instruction stand-by operation is to be performed after the end of the preliminary drive operation (step S32), the user is notified that the voice instruction stand-by operation is not to be performed before the end of the preliminary drive operation (step S34; see also FIG. 7). As a result, the user can know that any voice emitted by the user during the preliminary drive operation (or in a state in which the MFP 1 is not waiting for a voice instruction) is not to be received by the MFP 1. Thus, it is possible to prevent the user from unnecessarily uttering a word.

In one or more embodiments, in a case where it is determined that the voice instruction stand-by operation is to be performed after the end of the preliminary drive operation, a notification process is performed to notify the user that the voice instruction stand-by operation is not to be performed before the end of the preliminary drive operation. However, the present invention is not limited to this, and the notification process is not necessarily performed. In a case where the notification process is not performed, even if the user emits a voice during the preliminary drive operation, the voice instruction from the user is not accepted before the end of the preliminary drive operation, and a voice recognition process is not performed. Accordingly, it is possible to prevent execution of a voice recognition process (or execution of an unnecessary voice recognition process) within a period during which the voice recognition rate might drop (the period of execution of the preliminary drive operation).

The description below will focus on the differences from the embodiments described above.

In the embodiments described above, in a case where a transition instruction is received, it is invariably determined that a preliminary drive operation is to be performed after the end of a voice instruction stand-by operation (step S12 (FIG. 4)).

In one or more embodiments, on the other hand, the respective timings to perform the preliminary drive operation and the voice instruction stand-by operation are adjusted, on the basis of the contents of settings relating to a preferential operation (the voice instruction stand-by operation or the preliminary drive operation, whichever is to be preferentially performed in response to an instruction to transition to an activated state).

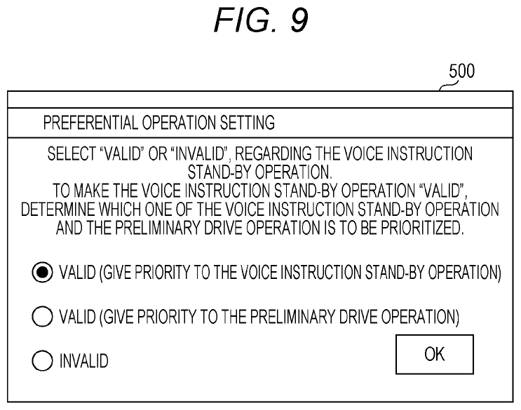

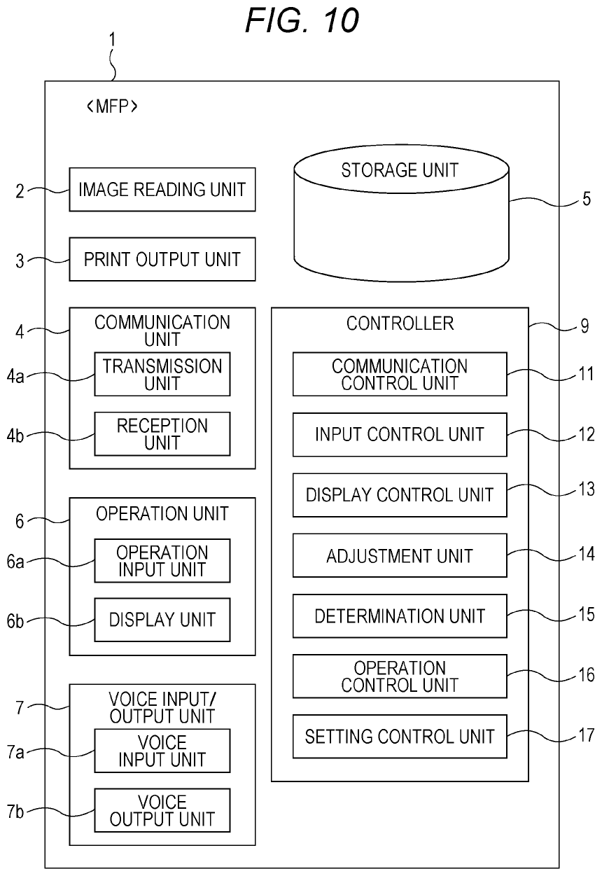

FIG. 9 is a diagram showing a preferential operation setting screen 500 for accepting a preferential operation setting operation. FIG. 10 is a diagram showing the functional blocks of an MFP 1 according to one or more embodiments. As shown in FIG. 10, the controller 9 of the MFP 1 in one or more embodiments further includes a setting control unit 17 that can set the preferential operation.

Prior to issuance of an instruction for a transition to an activated state, the user uses the preferential operation setting screen 500 (FIG. 9), to perform an operation to set the validity (“valid/invalid”) of the voice instruction stand-by operation, and perform an operation to set a preferential operation (the voice instruction stand-by operation or the preliminary drive operation, whichever is to be preferentially (first) performed in response to the instruction for a transition to an activated state).

For example, in a case where the user has a larger number of opportunities to use voice for giving an instruction to the MFP 1 (than the number of the opportunity to use the operation unit 6), the user makes the voice instruction stand-by operation valid, and sets the voice instruction stand-by operation as the preferential operation, through the preferential operation setting screen 500.

Further, in a case where the user has opportunities to use voice for giving an instruction to the MFP 1, but has a larger number of opportunities to use the operation unit 6 (than the number of opportunities to use voice) for giving the instruction, the user makes the voice instruction stand-by operation valid, and sets the preliminary drive operation as the preferential operation, through the preferential operation setting screen 500.

Further, in a case where the user does not have any opportunity to use voice for giving an instruction to the MFP 1, the user makes the voice instruction stand-by operation invalid through the preferential operation setting screen 500.

In this manner, the user performs a preferential operation setting operation, taking into consideration the method of the user's use of the MFP 1. In response to the setting operation, the MFP 1 (specifically, the setting control unit 17) sets the preferential operation.

When the transition instruction is received after that, the operation described below is performed.

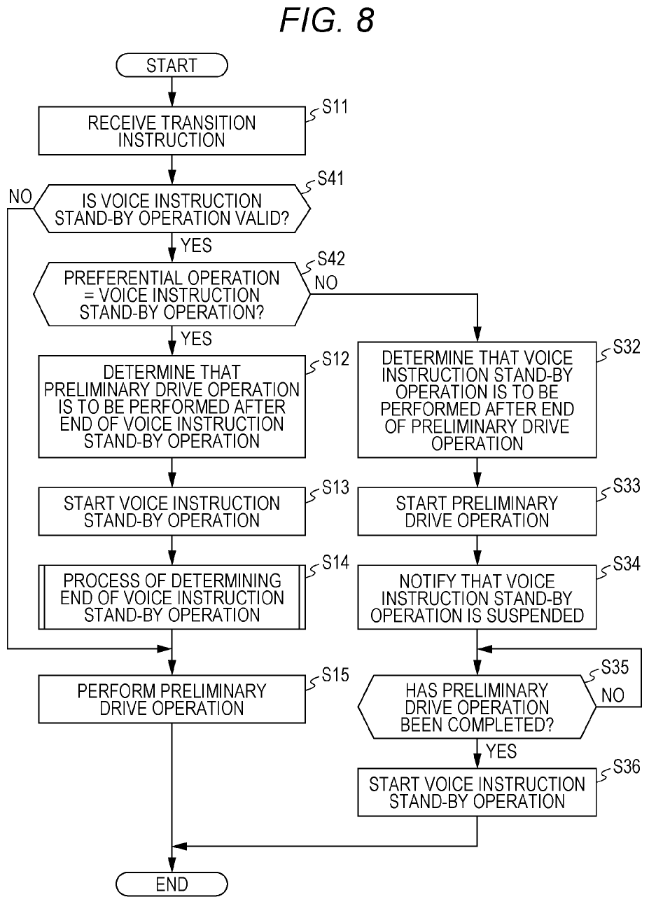

FIG. 8 is a flowchart showing operation of the MFP 1 according to one or more embodiments.

In one or more embodiments, the processes in steps S41, S42, and S32 through S36 are performed, in addition to the processes in steps S11 through S15 also shown in FIG. 4.

Specifically, when an instruction for a transition to an activated state is received (step S11), the MFP 1 (specifically, the adjustment unit 14) adjusts the respective timings to perform the voice instruction stand-by operation and the preliminary drive operation, on the basis of the contents of settings (the contents of settings set for the preferential operation by the setting control unit 17) on the preferential operation setting screen 500 (steps S41 and S42).

More specifically, the MFP 1 first determines the validity of the voice instruction stand-by operation (step S41).

For example, in a case where the voice instruction stand-by operation is set to “Invalid” on the preferential operation setting screen 500 (FIG. 9), the process proceeds from step S41 on to step S15 (skipping step S12 and others). The MFP 1 then performs the preliminary drive operation immediately (without performing the voice instruction stand-by operation) in response to the transition instruction (step S15). In a case where the voice instruction stand-by operation is set to “Invalid”, the user gives an instruction for a transition to an activated state, using the operation unit 6 or the like, instead of voice.

In a case where the voice instruction stand-by operation is set to “Valid” on the preferential operation setting screen 500, on the other hand, the process proceeds from step S41 on to step S42.

In step S42, the MFP 1 determines whether the voice instruction stand-by operation is set as the preferential operation.

In a case where the voice instruction stand-by operation is set as the preferential operation on the preferential operation setting screen 500, the process proceeds from step S42 on to steps S12 through S15. The contents of the processes in steps S12 through S15 are the same as those in the embodiments described above (FIG. 4). Specifically, it is determined that the preliminary drive operation is to be performed after the end of the voice instruction stand-by operation (step S12). The voice instruction stand-by operation is then started (step S13). After the end of the voice instruction stand-by operation (step S14), the preliminary drive operation is performed (step S15).

In a case where the preliminary drive operation is set as the preferential operation on the preferential operation setting screen 500, on the other hand, the process proceeds from step S42 on to steps S32 through S36. The contents of the processes in steps S32 through S36 are the same as those in the embodiments described above (FIG. 6). Specifically, it is determined that the voice instruction stand-by operation is to be performed after the end of the preliminary drive operation (step S32). The preliminary drive operation is then started (step S33). After the end of the preliminary drive operation (step S35), the voice instruction stand-by operation is performed (step S36).

As described above, in one or more embodiments, the voice instruction stand-by operation or the preliminary drive operation, whichever has been set as the preferential operation in advance, is performed first, and the other operation is performed after the end of the preferential operation.

The description below will focus on the differences from the embodiments described above.

In the embodiments described above, in a case where the timings to perform the respective operations are adjusted so that the preliminary drive operation is to be performed after the end of the voice instruction stand-by operation (see FIG. 3), the preliminary drive operation is invariably performed in both the scanner 2 and the printer 3.

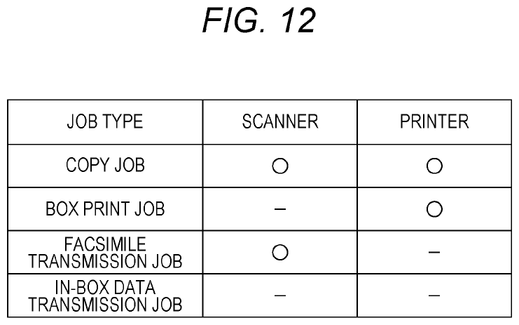

In that stage, the processor(s) that operate(s) in executing a job vary (varies) with each job type in the MFP 1. FIG. 12 is a diagram showing the presence/absence of operation of each processor for each job type.

For example, in a copy job, after a process of reading a document placed on the ADF or the like is performed by the scanner 2, a print output process based on the image data of the document is performed by the printer 3. That is, a copy job is a job that involves operation of both the scanner 2 and the printer 3 (see FIG. 12).

In a box print job (a job for performing a print output process based on the print target data stored beforehand in the MFP 1), the print output process based on the print target data is performed by the printer 3, but any document reading process is not performed by the scanner 2. That is, a box print job is a job that involves operation of the printer 3, but does not involve operation of the scanner 2 (see FIG. 12).

In a facsimile transmission job, a document reading process is performed by the scanner 2, but any print output process is not performed by the printer 3. That is, a facsimile transmission job is a job that involves operation of the scanner 2, but does not involve operation of the printer 3 (see FIG. 12).

Further, in an in-box data transmission job for transmitting data (transmission target data) stored beforehand in the MFP 1 to another device, neither a document reading process nor a print output process is performed. That is, an in-box data transmission job is a job that does not involve any operation of the printer 3 and the scanner 2 (see FIG. 12).

As described above, in the MFP 1, the processor(s) that operate(s) in executing a job vary (varies) with each job type.

Further, in a case where the preliminary drive operation is performed after the end of the voice instruction stand-by operation, the type of the job to be performed after the preliminary drive operation can be identified before the start of the preliminary drive operation, on the basis of a voice instruction (a job execution instruction) received in the voice instruction stand-by operation.

In view of these aspects, in a case where an adjustment process is performed so that the preliminary drive operation is to be performed after the end of the voice instruction stand-by operation in one or more embodiments, the processor(s) to perform the preliminary drive operation(s) is (are) changed in accordance with the type of the job received in the voice instruction stand-by operation.

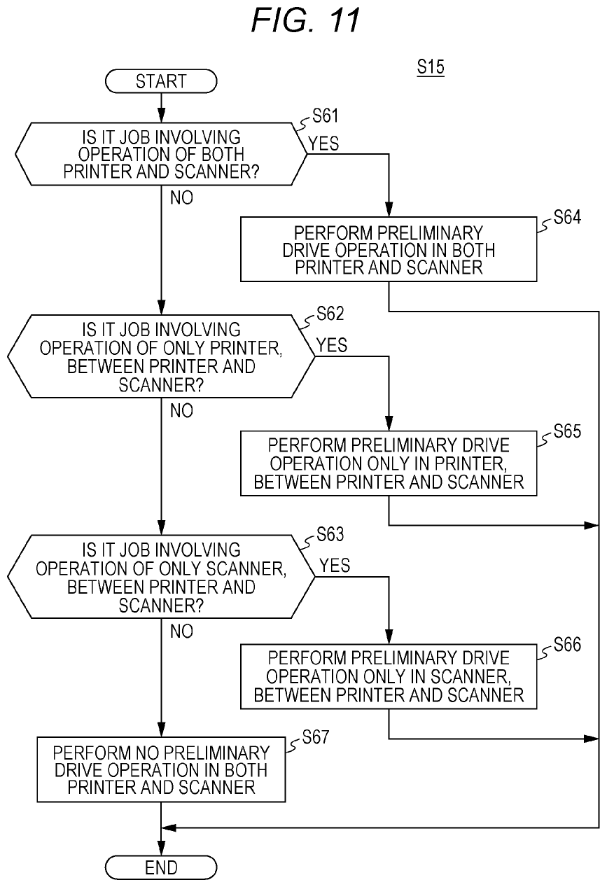

FIG. 11 is a diagram showing the subroutine process in the preliminary drive operation (step S15 in FIG. 4).

In this example, a job execution instruction (an execution instruction by voice) to execute a copy job, a box print job, a facsimile transmission job, or an in-box data transmission job is received in the voice instruction stand-by operation.

First, in step S61, the MFP 1 determines whether an instruction to execute a job that is to involve operation of both processors of the scanner 2 and the printer 3 has been received in the voice instruction stand-by operation.

In a case where an instruction to execute a job that is to involve operation of both of the processors has been received in the voice instruction stand-by operation, the process proceeds from step S61 on to step S64. For example, in a case where a copy job execution instruction has been received in the voice instruction stand-by operation, the process proceeds from step S61 on to step S64.

In step S64, the MFP 1 determines that both the preliminary drive operation in the scanner 2 and the preliminary drive operation in the printer 3 are to be performed. A slider moving operation or the like in a shading correction process is then performed as the preliminary drive operation in the scanner 2 of the MFP 1, and a transfer operation or the like in an image stabilization process is performed as the preliminary drive operation in the printer 3 of the MFP 1. After the preliminary drive operations in both the scanner 2 and the printer 3 are completed, the copy job is executed.

In a case where an instruction to execute a job that is not a job to involve operation of both of the processors of the scanner 2 and the printer 3 has been received in the voice instruction stand-by operation, the process proceeds from step S61 on to step S62. For example, in a case where an instruction to execute a job that is a box print job, a facsimile transmission job, or an in-box data transmission job has been received in the voice instruction stand-by operation, the process proceeds from step S61 on to step S62.

In step S62, the MFP 1 determines whether an instruction to execute a job that is to involve operation of only the printer 3 of the two processors of the scanner 2 and the printer 3 has been received in the voice instruction stand-by operation.

For example, in a case where an instruction to execute a job that is to involve operation of only the printer 3 of the two processors has been received in the voice instruction stand-by operation, the process proceeds from step S61 on to step S65 via step S62. For example, in a case where an instruction to execute a box print job has been received in the voice instruction stand-by operation, the process proceeds from step S61 on to step S65 via step S62.

In step S65, the MFP 1 determines that the preliminary drive operation in the printer 3 is to be performed, but the preliminary drive operation in the scanner 2 is not to be performed. A transfer operation or the like in an image stabilization process is then performed as the preliminary drive operation in the printer 3 of the MFP 1, but a slider moving operation or the like in a shading correction process is not performed as the preliminary drive operation in the scanner 2 of the MFP 1. After the preliminary drive operation in the printer 3 is completed, the box print job is executed.

In a case where an instruction to execute a job that is not a job to involve operation of only the printer 3 of the two processors of the scanner 2 and the printer 3 (the job is not a job to involve operation of both of the processors either) has been received in the voice instruction stand-by operation, the process proceeds from step S61 on to step S63 via step S62. For example, in a case where an instruction to execute a job that is a facsimile transmission job or an in-box data transmission job has been received in the voice instruction stand-by operation, the process proceeds from step S61 on to step S63 via step S62.

In step S63, the MFP 1 determines whether an instruction to execute a job that is to involve operation of only the scanner 2 of the two processors of the scanner 2 and the printer 3 has been received in the voice instruction stand-by operation.

In a case where an instruction to execute a job that is to involve operation of only the scanner 2 of the two processors has been received in the voice instruction stand-by operation, the process proceeds from step S61 on to step S66 via steps S62 and S63. For example, in a case where an instruction to execute a facsimile transmission job has been received in the voice instruction stand-by operation, the process proceeds from step S61 on to step S66 via steps S62 and S63.

In step S66, the MFP 1 determines that the preliminary drive operation in the scanner 2 is to be performed, but the preliminary drive operation in the printer 3 is not to be performed. A slider moving operation or the like in a shading correction process is then performed as the preliminary drive operation in the scanner 2 of the MFP 1, but a transfer operation or the like in an image stabilization process is not performed as the preliminary drive operation in the printer 3 of the MFP 1. After the preliminary drive operation in the scanner 2 is completed, the facsimile transmission job is executed.

In a case where an instruction to execute a job that is not a job to involve operation of only the scanner 2 of the two processors of the scanner 2 and the printer 3 (furthermore, the job is neither a job to involve operation of both of the processors, nor a job to involve operation of only the printer 3 of the two processors) has been received in the voice instruction stand-by operation, the process proceeds from step S61 on to step S67 via steps S62 and S63. For example, in a case where an instruction to execute an in-box data transmission job has been received in the voice instruction stand-by operation, the process proceeds from step S61 on to step S67 via steps S62 and S63.

In step S67, the MFP 1 determines that both the preliminary drive operation in the scanner 2 and the preliminary drive operation in the printer 3 are not to be performed. In this case, a slider moving operation or the like in a shading correction process is not performed as the preliminary drive operation in the scanner 2 of the MFP 1, and a transfer operation or the like in an image stabilization process is not performed as the preliminary drive operation in the printer 3 of the MFP 1 either. The in-box data transmission job is then executed.

As described above, in a case where an adjustment process is performed so that the preliminary drive operation is to be performed after the end of the voice instruction stand-by operation (see FIG. 3) in one or more embodiments, the processor(s) to perform the preliminary drive operation(s) is (are) changed in accordance with the type of the job received in the voice instruction stand-by operation. As a result, the preliminary drive operation is not performed in the processor(s) not to operate in executing the job received in the voice instruction stand-by operation, and the processor(s) is (are) maintained in a non-energized state. Thus, it is possible to achieve a decrease in power consumption (power saving).

Although one or more embodiments are described as a modification of the embodiments described above, one or more embodiments is not necessarily a modification of the embodiments described above, but the idea of one or more embodiments may be applied the embodiments described above.

For example, in the embodiments described above, in a case where it is determined that the preliminary drive operation is to be performed after the end of the voice instruction stand-by operation because of reception of a transition instruction by voice (step S12 (FIG. 6)), the preliminary drive operation may be performed in the processor(s) corresponding to the type of the job received in the voice instruction stand-by operation.

Further, in the embodiments described above, in a case where it is determined that the preliminary drive operation is to be performed after the end of the voice instruction stand-by operation because the voice instruction stand-by operation is set as the preferential operation (step S12 (FIG. 8)), the preliminary drive operation may be performed in the processor(s) corresponding to the type of the job received in the voice instruction stand-by operation.

### 5. Modifications and Others

Although one or more embodiments of the present invention have been described so far, the present invention is not limited to the contents of the above description.

For example, in the embodiments described above, in a case where an instruction for a transition from a power-saving state to an activated state is issued by voice, whether to perform an adjustment process may be determined depending on whether the volume of the voice is higher than a certain level.

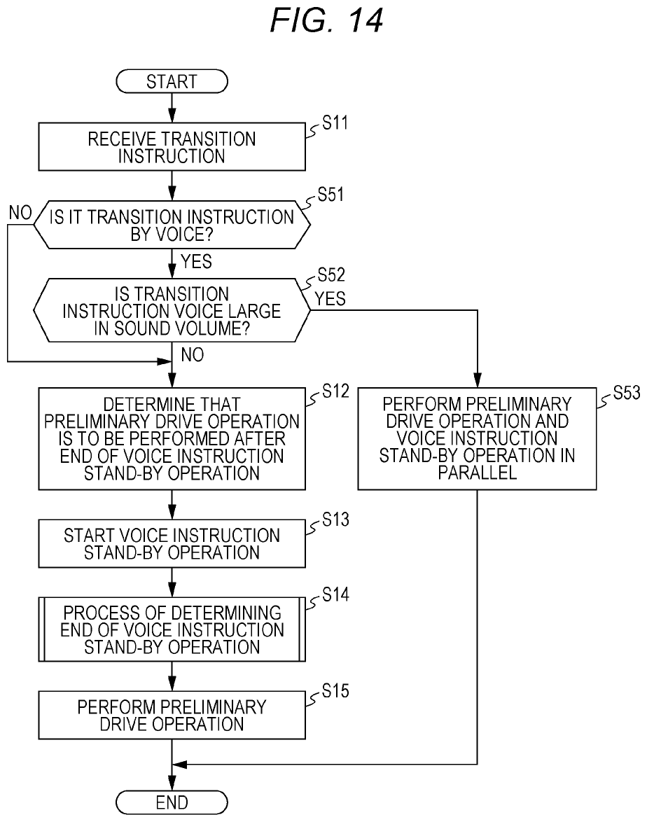

FIG. 14 is a flowchart showing operation of an MFP 1 according to this modification. In this example, the idea of this modification is applied to the embodiments described above.

Specifically, when an instruction for a transition from a power-saving state to an activated state is received (step S11), the MFP 1 determines whether the transition instruction has been issued by voice (step S51).

In a case where the transition instruction has been issued not by voice (but with the operation unit 6 or the like), the processes in step S51 and steps S12 through S15 are performed. The contents of the processes in steps S12 through S15 are the same as those in the embodiments described above.

In a case where the transition instruction has been issued by voice, on the other hand, the process proceeds from step S51 on to step S52.

In step S52, the MFP 1 determines whether the volume of the voice of the transition instruction is higher than a certain level.

In a case where the volume of the voice of the transition instruction is lower than the certain level, the MFP 1 performs a process of adjusting the respective timings to perform the voice instruction stand-by operation and the preliminary drive operation. Specifically, the MFP 1 determines that the voice instruction stand-by operation is to be started in response to the transition instruction, and the preliminary drive operation is to be performed after the end of the voice instruction stand-by operation (step S12). The voice instruction stand-by operation is then started in response to the transition instruction (step S13). After the end of the voice instruction stand-by operation, the preliminary drive operation is performed (step S15).

In a case where the volume of the voice of the transition instruction is higher than the certain level, on the other hand, the MFP 1 does not perform the adjustment process, and allows the voice instruction stand-by operation and the preliminary drive operation to be performed in parallel. Specifically, in response to the transition instruction, the MFP 1 starts both the voice instruction stand-by operation and the preliminary drive operation (step S52).

To be more specific, in a case where the volume of the voice of the transition instruction is higher than the certain level, the MFP 1 presumes that the volume of the voice of a voice instruction received in the voice instruction stand-by operation is also higher than the certain level. In other words, even in a case where driving sound of the mechanical drive mechanism and the user's voice overlap each other, the MFP 1 presumes that the degree of decrease in the voice recognition rate is lower than a predetermined level. Therefore, the MFP 1 does not perform the adjustment process described above, and allows the voice instruction stand-by operation and the preliminary drive operation to be performed in parallel. Specifically, in response to the transition instruction, the MFP 1 starts both the voice instruction stand-by operation and the preliminary drive operation.

In a case where the adjustment process is invariably performed, the start of job execution (and the completion of the job) is delayed, because the voice instruction stand-by operation and the preliminary drive operation are executed sequentially (one by one). As a result, the user's waiting time becomes longer.

In this modification, on the other hand, in a case where an instruction for a transition from a power-saving state to an activated state is issued by voice, whether to perform a process of adjusting the respective timings to perform the voice instruction stand-by operation and the preliminary drive operation is determined depending on whether the volume of the voice is higher than a certain level. Specifically, in a case where the volume of the voice of the transition instruction is higher than the certain level, the adjustment process is not performed, and the voice instruction stand-by operation and the preliminary drive operation are allowed to be performed in parallel. As a result, the job is started earlier than in a case where the voice instruction stand-by operation and the preliminary drive operation are performed one by one. Thus, it is possible to prevent the generation of the user's waiting time caused by execution of the adjustment process.

Although an example in which the idea of this modification is applied to the embodiments described above is described herein, the invention is not limited to this, and the idea of this modification may be applied to one or more embodiments.

Specifically, in one or more the embodiments, a check may be further made to determine whether the volume of the voice of the transition instruction is higher than a certain level, between step S31 (FIG. 6) and step S12. If the volume is higher than the certain level, the voice instruction stand-by operation and the preliminary drive operation may be performed in parallel. If the volume is lower than the certain level, on the other hand, the preliminary drive operation may be performed after the end of the voice instruction stand-by operation.

Further, in a case where a transition instruction has been issued by voice in one or more embodiments, a check may be further made to determine whether the volume of the voice of the transition instruction is higher than a certain level, between step S41 (FIG. 8) and step S42. If the volume is higher than the certain level, the voice instruction stand-by operation and the preliminary drive operation may be performed in parallel. If the volume is lower than the certain level, on the other hand, the order of execution of the voice instruction stand-by operation and the preliminary drive operation may be determined in accordance with the contents of settings relating to the preferential operation.

Further, in one or more embodiments, in a case where an instruction for a transition from a power-saving state (or a power-off state) to an activated state has been issued, it is invariably determined that the preliminary drive operation is to be performed after the end of the voice instruction stand-by operation (step S12 (FIG. 4)). However, the present invention is not limited to this.

For example, in a case where the transition instruction has been issued, it may be invariably determined that the voice instruction stand-by operation is to be performed after the end of the preliminary drive operation. In this case, it may further perform a notification process for notifying the user that the voice instruction stand-by operation is to be performed after the end of the preliminary drive operation (see FIG. 7). Even in a case where the notification process is not performed, a voice instruction from the user is not to be received before the end of the preliminary drive operation, as described above. Thus, it is possible to avoid execution of an unnecessary voice recognition process, and may perform a voice recognition process.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An image forming apparatus comprising:
an operation panel that receives from a user a transition instruction to transition a power switch of the image forming apparatus from a power-off state or a power-saving state to an activated state; and
a hardware processor that adjusts respective timings to perform a voice instruction stand-by operation and a preliminary drive operation, wherein
the hardware processor performs the voice instruction stand-by operation to wait for a voice instruction from the user after receiving the transition instruction,
the hardware processor performs the preliminary drive operation after receiving the transition instruction but before a transition to the activated state, and
upon receiving the transition instruction, the hardware processor adjusts the timings to prevent the voice instruction stand-by operation and the preliminary drive operation from overlapping each other.

2. The image forming apparatus according to claim 1, wherein
the hardware processor adjusts the timings to perform one of the voice instruction stand-by operation and the preliminary drive operation once the other one of the voice instruction stand-by operation and the preliminary drive operation ends.

3. The image forming apparatus according to claim 2, wherein
upon determining that the transition instruction is issued by voice, the hardware processor adjusts the timings to perform the preliminary drive operation once the voice instruction stand-by operation ends.

4. The image forming apparatus according to claim 3, wherein
upon determining that the transition instruction is issued by voice, the hardware processor adjusts the timings to start the preliminary drive operation once the voice instruction stand-by operation ends.

5. The image forming apparatus according to claim 4, wherein
upon determining that the voice instruction is completed, the hardware processor ends the voice instruction stand-by operation and starts the preliminary drive operation.

6. The image forming apparatus according to claim 4, wherein
upon determining that a state in which the voice instruction is not received lasts longer than a predetermined time, the hardware processor ends the voice instruction stand-by operation and starts the preliminary drive operation.

7. The image forming apparatus according to claim 3, wherein
upon determining that the transition instruction is issued not by voice, the hardware processor adjusts the timings to perform the voice instruction stand-by operation once the preliminary drive operation ends and notifies the user that the voice instruction stand-by operation will not be performed until the preliminary drive operation ends.

8. The image forming apparatus according to claim 2, wherein
the hardware processor sets a preferential operation prior to the transition instruction,
the preferential operation is one of the voice instruction stand-by operation and the preliminary drive operation that is preferentially performed, and
the hardware processor adjusts the timings based on contents of settings with respect to the preferential operation.

9. The image forming apparatus according to claim 8, wherein
when the preliminary drive operation is set as the preferential operation and once the preliminary drive operation ends, the hardware processor adjusts the timings to perform the voice instruction stand-by operation and notifies the user that the voice instruction stand-by operation will not be performed until the preliminary drive operation ends.

10. The image forming apparatus according to claim 8, wherein
when the voice instruction stand-by operation is set as the preferential operation and once the voice instruction stand-by operation ends, the hardware processor adjusts the timings to perform the preliminary drive operation.

11. The image forming apparatus according to claim 8, wherein
when the voice instruction stand-by operation is set as the preferential operation and once the voice instruction stand-by operation ends, the hardware processor adjusts the timings to start the preliminary drive operation .

12. The image forming apparatus according to claim 11, wherein
upon determining that the voice instruction is completed, the hardware processor ends the voice instruction stand-by operation and starts the preliminary drive operation.

13. The image forming apparatus according to claim 11, wherein
upon determining that a state in which the voice instruction is not received lasts longer than a predetermined time, the hardware processor ends the voice instruction stand-by operation and starts the preliminary drive operation.

14. The image forming apparatus according to claim 2, further comprising:
a first processor; and
a second processor, wherein
the image forming apparatus performs, as the preliminary drive operation, a first drive operation by the first processor and a second drive operation by the second processor,
when the hardware processor adjusts the timings to perform the preliminary drive operation once the voice instruction stand-by operation ends and an instruction to execute a job is received in the voice instruction stand-by operation, the hardware processor determines that the first drive operation is performed as the preliminary drive operation and the second drive operation is not performed as the preliminary drive operation, and
the job involves an operation by the first processor but does not involve an operation by the second processor.

15. The image forming apparatus according to claim 2, further comprising:
a first processor; and
a second processor, wherein
the image forming apparatus performs, as the preliminary drive operation, a first drive operation by the first processor and a second drive operation by the second processor,
when the hardware processor adjusts the timings to perform the preliminary drive operation once the voice instruction stand-by operation ends and an instruction to execute a job is received in the voice instruction stand-by operation, the hardware processor determines that both the first drive operation and the second drive operation are not performed as the preliminary drive operation, and
the job does not involve an operation by either of the first processor and the second processor.

16. The image forming apparatus according to claim 14, wherein
the first processor is one of a printer or a scanner of the image forming apparatus, and
the second processor is the other of the printer or the scanner of the image forming apparatus.

17. The image forming apparatus according to claim 1, wherein
upon determining that the transition instruction is issued by voice and that a volume of the voice is lower than a certain level, the hardware processor adjusts the timings, and
upon determining that the transition instruction is issued by voice and that the volume is higher than the certain level, the hardware processor does not adjust the timings and allows the voice instruction stand-by operation and the preliminary drive operation to be performed in parallel.

18. The image forming apparatus according to claim 1, wherein
the preliminary drive operation includes a transfer operation to transfer a toner image onto an intermediate transfer belt in an image stabilization process, and
the transfer operation involves driving of the intermediate transfer belt.

19. The image forming apparatus according to claim 1, wherein
the preliminary drive operation includes a slider moving operation in which a slider moves between a predetermined position and a shading correction position in a shading correction process.

20. A non-transitory recording medium storing a computer readable program for causing a computer of an image forming apparatus to execute:
receiving from a user a transition instruction to transition a power switch of the image forming apparatus from a power-off state or a power-saving state to an activated state;
adjusting respective timings to perform a voice instruction stand-by operation and a preliminary drive operation, wherein the voice instruction stand-by operation causes the image forming apparatus to wait for a voice instruction from the user after receiving the transition instruction, and the preliminary drive operation is performed by the image forming apparatus after receiving the transition instruction but before a transition to the activated state; and
upon receiving the transition instruction, adjusting the timings to prevent the voice instruction stand-by operation and the preliminary drive operation from overlapping each other.

21. A method of controlling an image forming apparatus, the method comprising:
receiving from a user a transition instruction to transition a power switch of the image forming apparatus from a power-off state or a power-saving state to an activated state;
adjusting respective timings to perform a voice instruction stand-by operation and a preliminary drive operation, wherein the voice instruction stand-by operation causes the image forming apparatus to wait for a voice instruction from the user after receiving the transition instruction, and the preliminary drive operation is performed by the image forming apparatus after receiving the transition instruction but before a transition to the activated state; and
upon receiving the transition instruction, adjusting the timings to prevent the voice instruction stand-by operation and the preliminary drive operation from overlapping each other.
